(19) United States
(12) Patent Application Publication
(10) Pub. No.: US 2004/0193392 A1
(43) Pub. Date: Sep. 30, 2004

(54) Object interaction simulation

(76) Inventors: Richard Andrew Williams, Harrogate (GB); Xiaodong Jia, Leeds (GB)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/469,432

(22) PCT Filed: Feb. 26, 2002
(86) PCT No.: PCT/GB02/00786

(30) Foreign Application Priority Data
Feb. 28, 2001 (GB) 0104931.1

(51) Int. Cl. G06F 17/10

(52) U.S. Cl. 703/2

(57) ABSTRACT

A computer implemented method for simulating interactions between relatively movable objects of arbitrary shapes and sizes wherein a space to be modelled is mapped to a grid of cells each of which is a basic spatial element; a first object is mapped to a first set of grid cells representing the shape of the first object and a second object is mapped to a second set of grid cells representing the shape of the second object, movement of at least one of the objects through the modelled space is simulated by mapping the moved object to an updated set of grid cells selected to represent the shape of the moved object after a predetermined stepwise movement of the object, and movements which would result in sets of cells representing different objects including a common cell are precluded. Each basic spatial element may be a pixel or a voxel.

The present invention relates to a computer implemented method of simulating interactions between relatively movable objects, and more particularly to a method that may be used to study the packing of particles, of arbitrary shape/size, within a container of arbitrary geometry.

There are many applications of spatial collision/overlap detection. These arise in all areas of the computer graphics industry including gaming and more recently virtual environment simulation. An additional application is the study of the packing of particles within a container.

Particle packing is an age old problem to which a number of different approaches have been taken. In this document, particle packing is used to mean ‘arranging’ or ‘putting together’ particles in a confined space. This packing may be achieved by any means including, for example, stacking oranges by hand at a grocer, filling silos in a bulk handling plant, or packaging pharmaceutical tablets in a container. For rigid solids, geometric constraints or steric-hindrance will determine the compactness of the packing structure, regardless of the packing process.

A class of computer methods exist that seek to generate packing structures by exploring geometric constraints. These are known as packing algorithms and can conveniently be considered as falling into one of three groups, each of which is discussed below.

The first group comprises ballistic algorithms. Here particles are considered to follow well defined trajectories to find a resting place in the resulting packing. An example of the use of these algorithms is given in: M. J. Vold: The sediment volume in dilute suspension of spherical particles, J. Phys Chem 64 (1960) 1616-1671. Although relatively computationally efficient, they are very difficult to use with containers of complex geometry as particle trajectories will be very difficult to calculate.

The second group contains random placement algorithms. Here particles are placed in the container one by one in randomly selected positions. If the particle being placed overlaps with another in a given position an alternative position is tried. This continues for a predetermined number of iterations after which the particle is discarded if placement without overlap has not been achieved. This algorithm, although straightforward to implement for containers of any geometry, is highly inefficient. It is also highly dependant on the order of insertion of the particles into the container.

The third group contains growth algorithms. Here, points in the packing space are allowed to grow to yield shapes of the required geometry and size. In order to obtain a dense packing rearrangements are usually required and these can cause the algorithm to perform very slowly.

In all the approaches outlined above, as in many computational tasks, difficulties occur at three levels namely mathematical, implementation and computational levels.

Mathematical difficulties are encountered as it is very difficult to derive mathematical models for objects of non trivial geometry that are likely to be the subject of a packing algorithm in a real industrial or commercial context. Additionally, the descriptions can not be easily represented and manipulated in the memory of a computer.

Implementation level difficulties occur in two ways. Firstly, it is notoriously difficult to effectively and efficiently perform collision detection and this is a research area in its own right. Even simple shapes such as regular polygons may cause unexpected difficulties. Even when an implementation is found, there is no guarantee that it will be widely applicable to a range of particles. The second difficulty arises from the well-known phenomenon of rounding errors caused by the use of floating point numbers in calculations. By their very nature, digital computers can only represent such numbers with finite precision.

The third set of difficulties arise from a computational point of view. In known computer based graphics systems, two-dimensional shapes are represented as being a collection of points and line segments and three-dimensional shapes as being a collection of polygons and spheres. Typically, very large numbers of these simple elements are required to model one particle. This difficulty means that even if the earlier problems can be overcome, the computer program code will be so complex, and demanding on both computer memory and processor power that it will not be practical to use widely

As mentioned above, the particles of interest may be modelled using a sphere composite approach in some of the methods discussed. That is the particles are broken down into a number of spheres. This suffers from the disadvantage that an analytical process is required to decompose the particle into spheres, a process often performed by a human with machine assistance. This approach also suffers from the computational limitations outlined above.

The present invention seeks to provide a basis for a packing algorithm that obviates or mitigates some or all of the difficulties outlined above.

According to the present invention there is provided a computer implemented method for simulating interactions between relatively movable objects wherein a space to be modelled is mapped to a grid of cells each of which is a basic spatial element; a first object is mapped to a first set of grid cells representing the shape of the first object and a second object is mapped to a second set of grid cells representing the shape of the second object, movement of at least one of the objects through the modelled space is simulated by mapping the moved object to an updated set of grid cells selected to represent the shape of the moved object after a predetermined stepwise movement of the object, and movements which would result in sets of cells representing different objects including a common cell are precluded. It is preferred that each grid cell is a pixel or a voxel.

In this document the term pixel is used to mean picture element, that being the basic building block one chooses for digital shapes, and that usually conveniently but not exclusively being the smallest two-dimensional element that can be represented by a computer graphics system. The term voxel is used to mean volume element, analogously being the basic building block of digitally represented shapes, and usually conveniently but not exclusively being the smallest three-dimensional element that can be represented by a system operating with three-dimensional data.

One of the objects may represent the sides of a container into which another object is to be packed.

It is preferable that movement in a predetermined direction is allowed in accordance with a specified probability factor and also preferable that the movement of an object includes rotation. A plurality of objects may move simultaneously.

Preferably, means are provided to simulate the effects of physical forces between objects and most preferably means are provided to simulate the effect of vibration by allowing objects the freedom to move in a predetermined manner relative to the grid after a collision is detected.

One object may represent a boundary of a container. Suitably, a boundary may be defined and a periodical boundary condition or virtual wall boundary condition may be applied to any object which overlaps the defined boundary. Means may be provided to simulate the addition of objects to the container at a common point. A plurality of objects may be added at any time from a plurality of points. An object colliding with another object or with a boundary deforms in a predetermined way.

According to a second aspect of the present invention there is provided a device for carrying out the method of the invention as described above

The process of digitisation and specific applications of the present invention will now be described, by way of example, with reference to the accompanying figures in which:

FIG. 1 is an illustration of the process known in the art as digitisation;

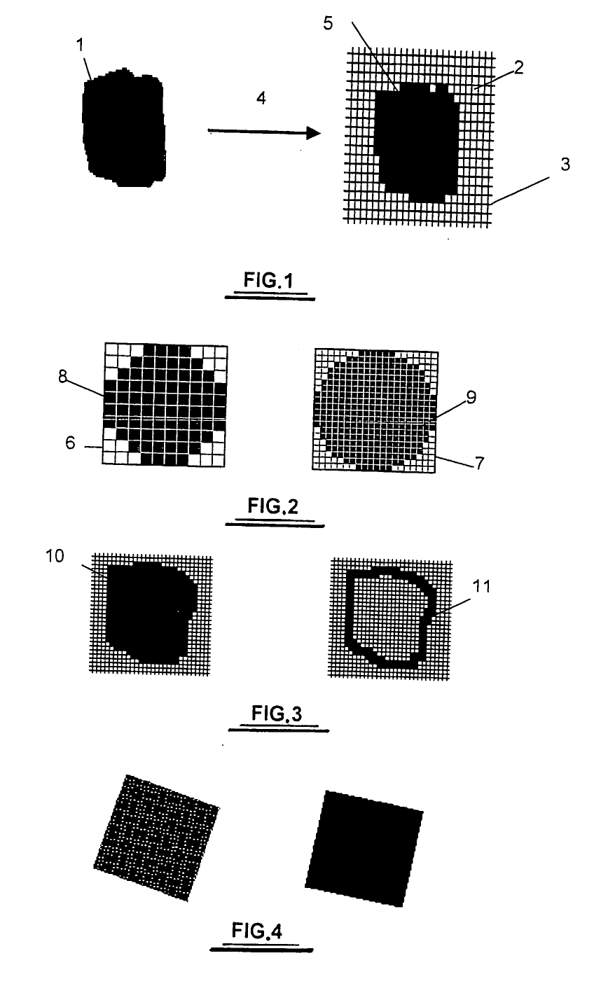

FIG. 2 is an illustration illustrating the accuracy of the digitisation process;

FIG. 3 is an illustration showing an enhancement of the digitisation process;

FIG. 4 is an illustration showing how rotations may be performed in an embodiment of the invention;

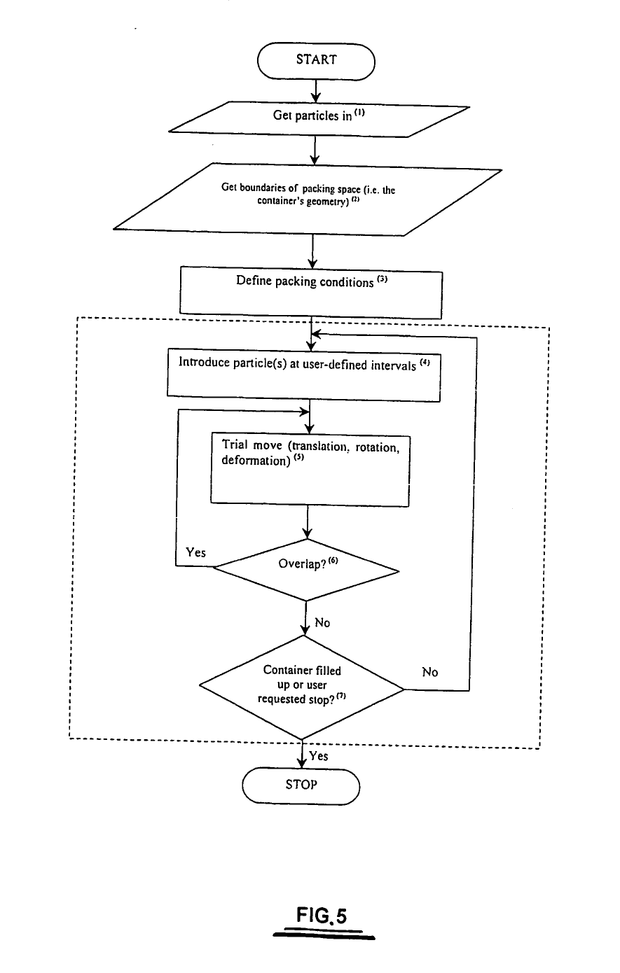

FIG. 5 is a flow diagram outlining the packing process according to the invention;

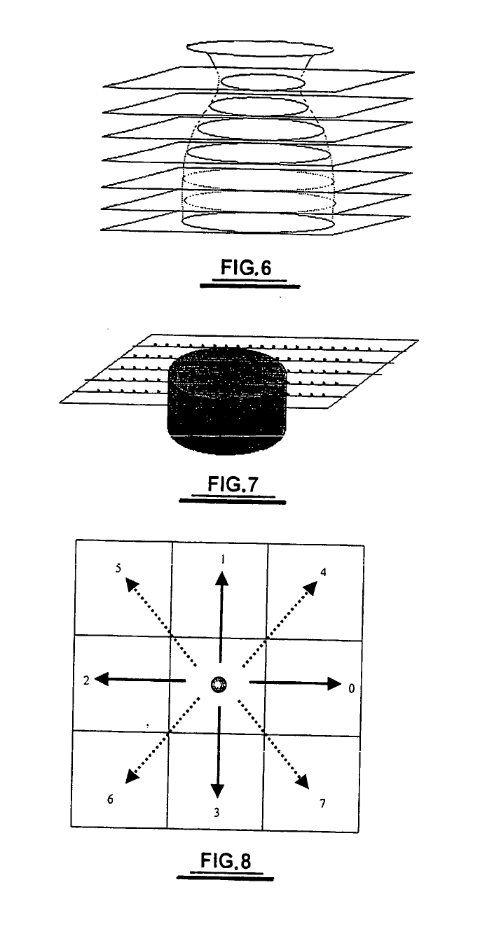

FIG. 6 is a schematic illustration of the process of capturing a three-dimensional object in slices;

FIG. 7 is a schematic illustration of the process of capturing three-dimensional object using a grid based approach;

FIG. 8 is a schematic illustration showing possible directions of particle movement on a grid;

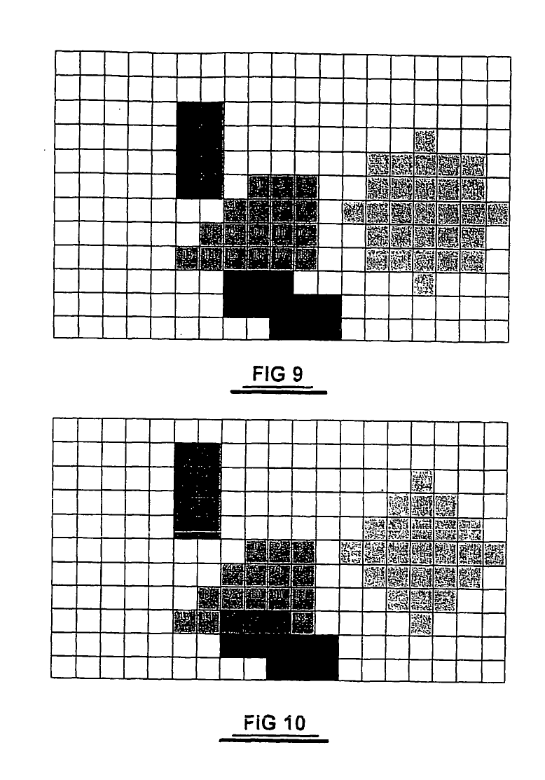

FIGS. 9 and 10 illustrate a simple particle movement operation performed in an embodiment of the invention;

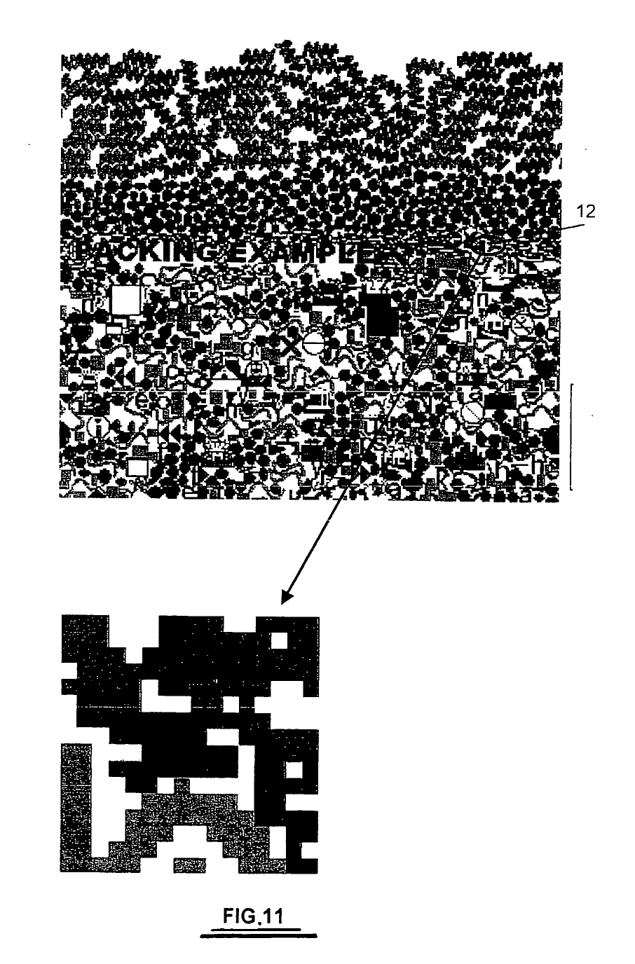

FIG. 11 is an illustration showing a packing structure established in accordance with the present invention and an enlarged detail of that structure;

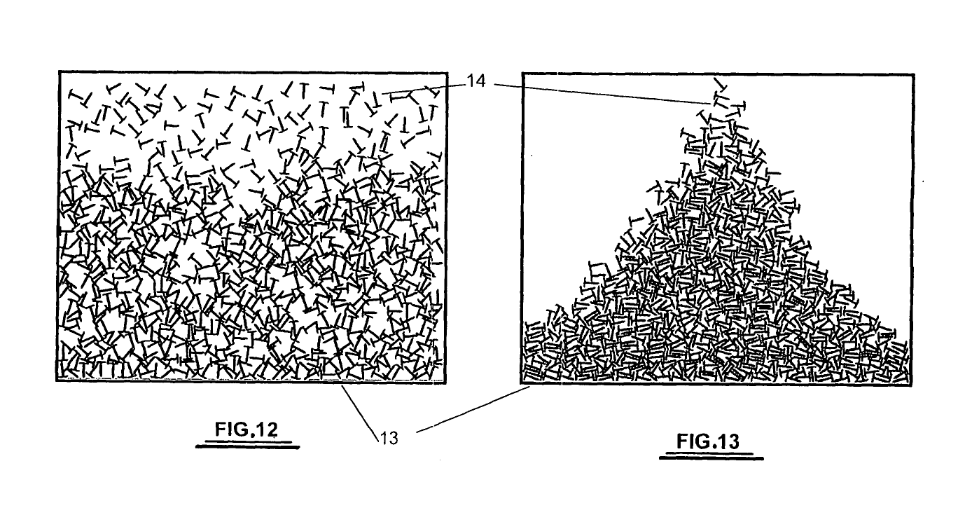

FIGS. 12 and 13 are illustrations showing the effects of varying parameter values provided by an algorithm used in an embodiment of the invention;

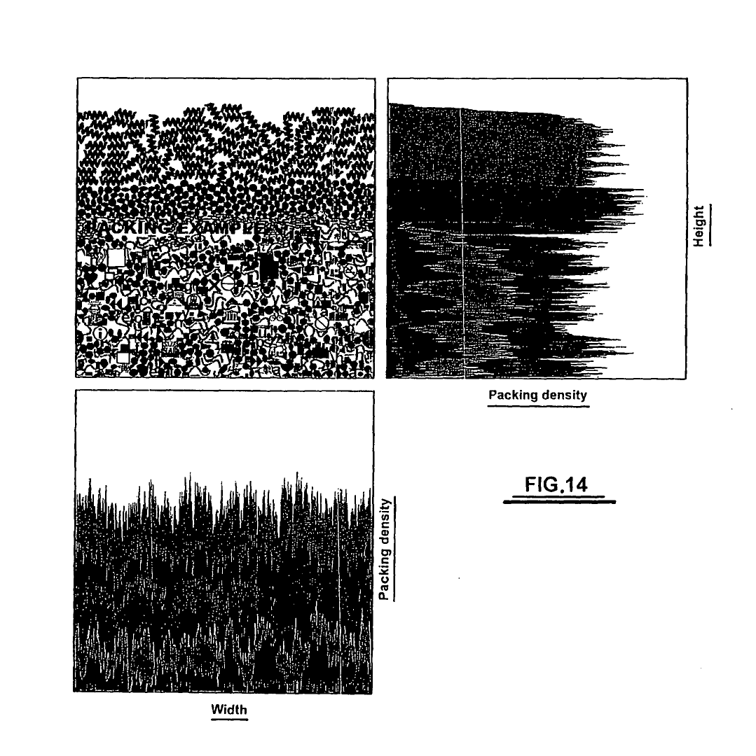

FIG. 14 is an illustration showing packing density variation along the width and height of a container in the same case as that illustrated in FIG. 11;

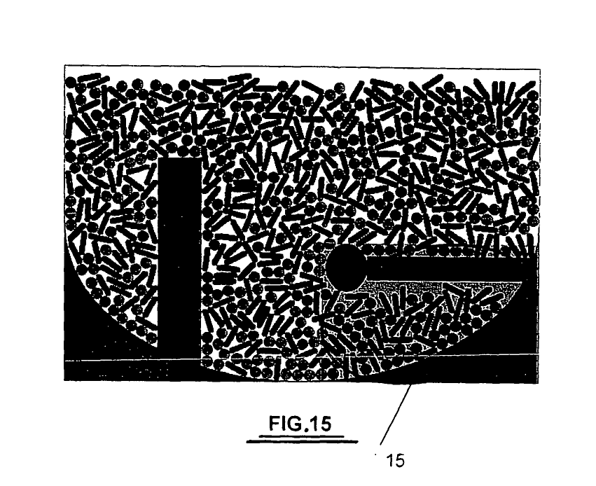

FIG. 15 is an illustration showing how rebounding may be used to pack containers having difficult to reach areas;

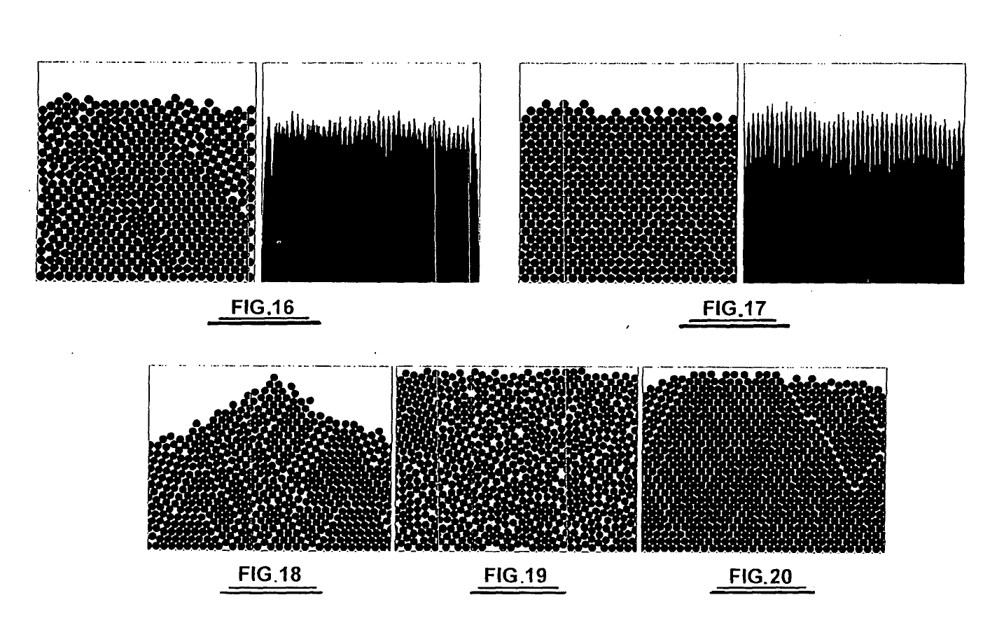

FIGS. 16 and 17 show a comparison of the packing densities achieved under various boundary conditions;

FIGS. 18, 19 and 20 are comparative illustrations of packing configurations under different conditions;

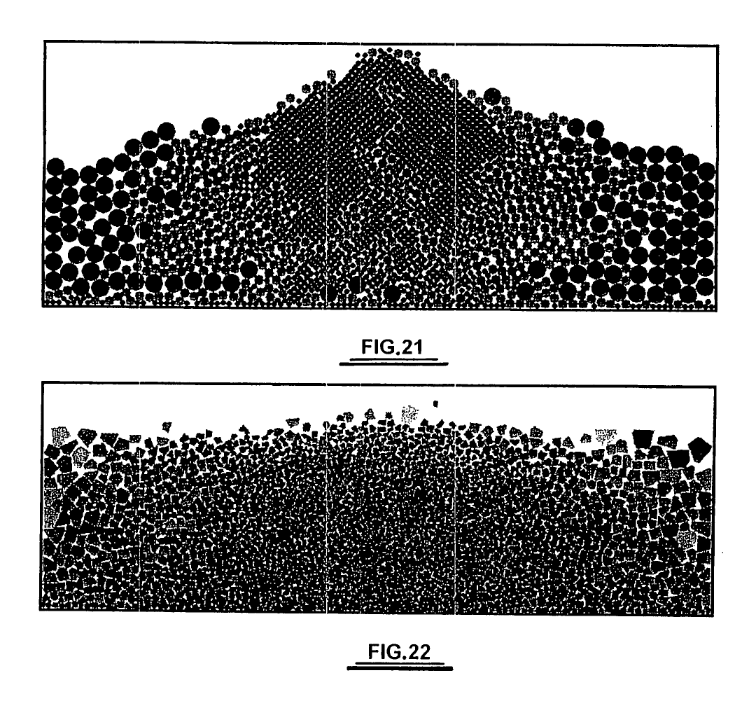

FIGS. 21 and 22 are illustrations showing how rapid small amplitude vibration may be modelled by the algorithm;

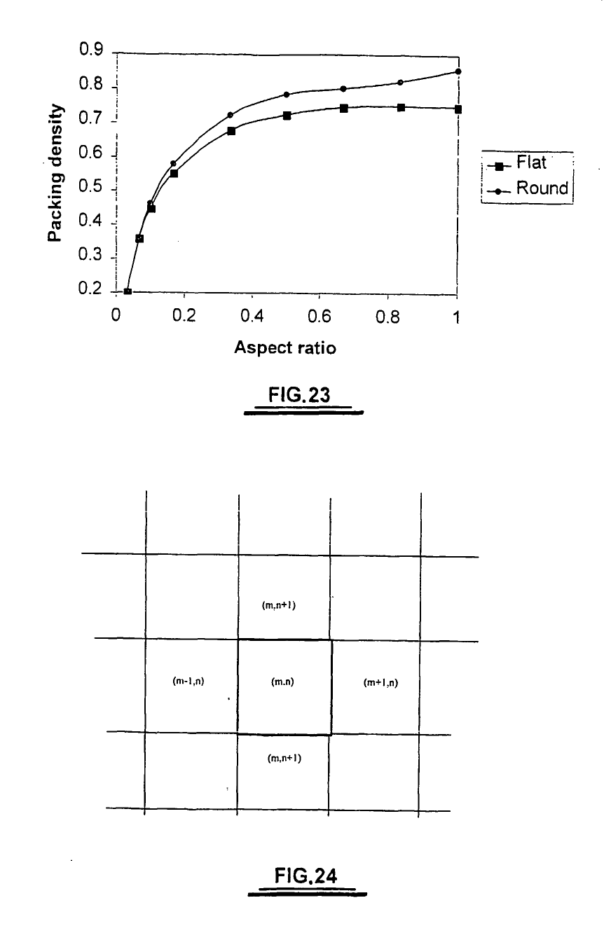

FIG. 23 is a graph showing the effect of aspect ratio on packing density;

FIG. 24 is an illustration of the nearest neighbours of a grid cell; and

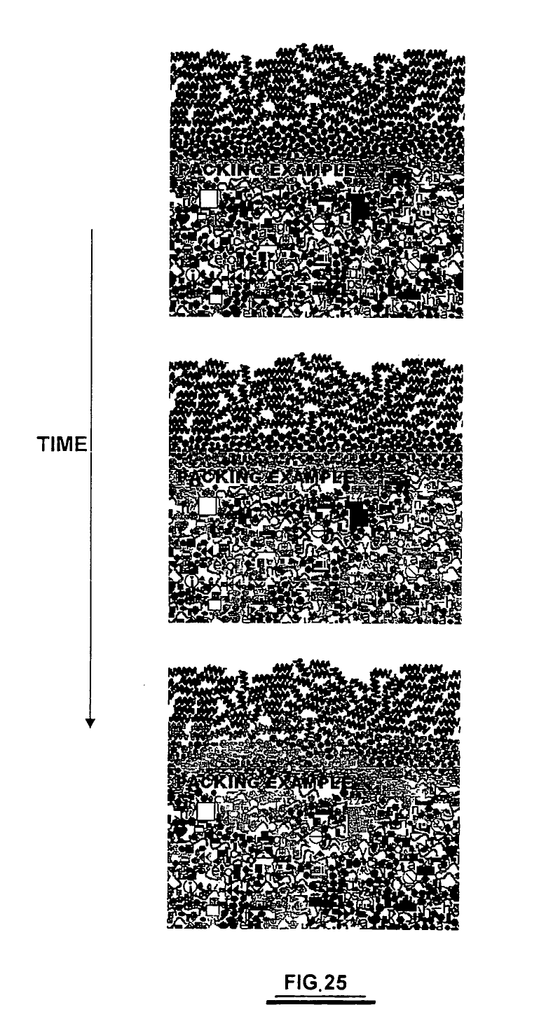

FIG. 25 is an illustration of heat transfer by conduction through the digitised structure of FIG. 11 over time.

Referring to FIG. 1, an object, 1 is mapped to cells 2 of a regular grid 3. This process is represented by arrow 4 and is known as digitisation. This results in a collection 5 of basic spatial elements representing the object. The basic spatial elements will be pixels in two-dimensions or voxels in three-dimensions.

It will be apparent that the conversion of an arbitrary object into a number of regular, basic spatial elements is likely to result in some inaccuracy and this effect is shown in FIG. 2. Here, a circle is digitised at two different resolutions, that is mapped to grids having cells of different size. Grid 6 consists of 100 elements, while grid 7 consists of 400 elements. It can thus be appreciated that the circle representation 8 on grid 6 is less accurate than the circle representation 9 on grid 7. However, it must also be remembered that use of a higher resolution will require more memory and processor power in any implementation.

Memory will increase in proportion to the square of the resolution. However, using FIG. 2 as an example, the relative error in digitisation on the low resolution grid is 3.2% compared with an error of 0.6% on the higher resolution grid. In practice accuracy and memory consumption must be carefully balanced depending upon the application.

For the purpose of collision detection, it is not necessary to digitise the whole object, but simply the outline in order to detect collisions between the boundaries of objects and this is shown in FIG. 3, in which a digitised object 10 is converted to an outline 11. Care must be taken when using this optimisation to ensure that the pixels that remain are sufficient to form a complete outline without holes—this is more likely to be a problem with highly irregular shapes. It is also possible that it may be necessary to reinstate the internal pixels for some applications. They include calculation of packing density and analysis of the resulting digitised structure for heat transfer characteristics and are discussed below.

In many computer graphics applications it is necessary to perform rotation operations. In pixel based approaches rotations using the standard mathematical rotation transformation can be a source of considerable rounding errors. An alternative therefore is to perform a rotation operation by using two successive shear operations along the x and y axes. The shear method of achieving rotations is well known. (see, for example, Alan W. Paeth: A fast algorithm for general raster rotation, in Graphics Gems, edited by Andrew S. Glassner, published by Academic Press Professional in 1990). Although it may not be possible to implement this alternative to operate as quickly, the effects of rounding errors are much reduced.

The benefits of using two shear operations is shown in FIG. 4. Here, the left hand square has been rotated using a standard rotation operation whilst the right hand square has been subject to two successive shear operations. It can be seen that in the left hand image rounding errors have resulted in holes appearing in the object. This has not occurred in the right hand image where the two successive shear operations will usually result in preservation of area, that is preservation of the number of pixels before and after the operation. There is therefore a choice between speed of operation and accuracy of result. It should be noted that errors do not accumulate provided that each rotation is from the original orientation, not the previous one.

Use of the invention will now be described with reference to a particle packing application. Referring to FIG. 5 the steps of the packing process are described. An overview of the process will be presented with the detail of some steps explained below. First the particles must be obtained in digitised state (step 1) and the geometry of the container must also be defined (step 2). It is likely that the implementation will provide a number of parameters relating to various parts of the packing process that may be varied by the user (step 3). These first three steps can be considered initialisation and the packing process can now begin. A particle or several particles are introduced into the container at user-defined intervals with each particle being allocated a sequential index number (step 4) and movement is attempted for each particle (step 5). If a collision occurs as a result of the movement this is detected (step 6) and an alternative move is attempted. This process continues until either the container is fill or the user requests that the packing process should stop (step 7).

In the subsequent description step numbers refer to steps of the flow chart of FIG. 5.

It is clear that in order to model the packing process it is necessary to obtain digitised images of the particles (step 1). For two-dimensional particles this can be achieved by drawing the shape on a second, hidden, grid using standard primitives provided by most computer programming environments and collecting the constituent pixels, or alternatively by scanning, storing the scanned image as a bitmap format file and then collecting the pixels.

Three-dimensional shapes may be scanned using a three-dimensional scanner and converted to a volumetric representation comprising voxels. Alternatively as shown in FIG. 6, the data may be obtained in slices using, for example, a standard X-ray tomographic scanner and the resultant slices may each be conveniently stored in bitmap format. The pixels making up each slice can be captured and the recombination of these slices will yield the required shape.

Another alternative three-dimensional capture mechanism is illustrated in FIG. 7. Here a three-dimensional shape is mapped to a grid and each cell is tested to see whether or not it lies within the grid. The cells making up the object are thus obtained.

Conventional computer graphics data structures can be conveniently used to store the particle description information. Each particle has a data structure storing pixel (or other basic spatial element) information alongside other necessary information including number of pixels, co-ordinates of each pixel in the local (pixel) co-ordinate system, local centre of the particle and dimensions. If the particle has been rotated two sets of pixel co-ordinates are stored, one original and one rotated.

It is also necessary to define the packing space itself (step 2), that is the grid on which the particles may be moved. In a two-dimensional representation this is a two-dimensional array, analogous to a standard pixel buffer Empty cells of the array are numbered 0. Each particle is allocated an index and an occupied site stores the index of the occupying particle. This data structure is updated after every move attempt.

The geometry of the container can be input in the same manner as that of a particle that is either by drawing using standard primitives or scanning and converting to pixels. It is not essential that the packing space be captured at the start, although it is logical and convenient to do so. If the container's geometry is not specifically defined, the entire simulation area or volume is used as the packing space. If a container geometry is imported later or a different container geometry is specified, particles outside the container or penetrating the container will be removed.

Steps 3 and 4 in the flowchart refer to packing conditions and insertion intervals respectively, both of which are described below.

Step 5 is implemented on a digital computer. The method operates using discrete time steps. At each time step an attempt is made to move each particle in the simulation. By default, every particle is subject to an attempted move at each time step. There are eight possible movement directions and these are shown in FIG. 8, although in some situations users may wish to disable diagonal directions (4,5,6,7). The direction of movement for each particle at each time step is decided by reference to one of the following:

If diagonal moves are allowed: rand( ) % 8

If diagonal moves are not allowed: rand ( ) % 4

Where rand is a standard function provided by the programming environment for the generation of random integers and % is the modulus operator, the result of which is the remainder obtained when the first operand is divided by the second operand.

In a simulation of particle packing, movement is required in a mainly downward direction although some upwards movement may occur as a result of rebounding. In order to encourage this downward movement the upward component (for diagonal directions 4 and 5 of FIG. 8) or the upward movement (for direction 1) is performed only with the rebounding probability factor that may be set for the system, according to:

urand( )<=Pr

Where urand is a standard function provided by the programming environment for the generation of random numbers uniformly distributed between 0 and 1 and Pr is the rebounding probability. The probability can take any user specified value between 0 and 1. A value of 0 prohibits any upward movement whilst a value of 1 means that upward movements are not restricted in any way and thus both upward and downward movements equally likely and there will be no settling and hence packing. In most situations a value between 0.2 and 0.5 will yield the most acceptable results.

Referring to FIG. 9, an object made up of eighteen pixels labelled 1 to 18 is to be moved on a grid which is also populated by other objects. A random direction for movement is chosen and the rebounding probability applied if an upward movement is selected. If a downward movement is attempted, an attempts are made to move all eighteen constituent pixels of the object in a downwards direction by one grid cell, as shown in FIG. 10. Such a movement would result in pixels labelled 15, 16 and 17 occupying the same space as another object. Thus an overlap is detected and either no further movement of the eighteen pixel object is attempted or a movement in another direction is attempted.

For the sake of efficiency, overlap may be detected by monitoring whether each new cell to be occupied by a pixel of the moved particle is either empty (represented by 0) or occupied by the current particle (represented by its index).In FIG. 10 when the downward move is attempted it will be seen that some of the cells onto which the move is proposed are already occupied. The move can not therefore take place and the particle is not moved during that step of the process. An alternative implementation may scan the array to identify sites containing pixels that belong to two objects. Such an approach is less efficient however as it requires a scan of each cell after each movement as opposed to simply inspecting the affected cells.

In the described example, objects move one grid cell at a time. This is a relatively easy approach to adopt, although it would be possible to move objects more than one grid cell at a time to speed up the approach of one object to another. It would be necessary however to ensure that one object could not “jump over” another object, or “jump into” a hollow object.

Referring to FIG. 11, a more complex packing structure is shown where very many particles have been packed together using the method described above. In building up the structure the container and each particle to be packed was digitised into a set of pixels. The particles were then moved within the container until they could move no further without overlap occurring. A small part 12 of the structure is also shown enlarged in FIG. 11. It can be seen that the entire structure is digitally represented as a collection of pixels.

Having described the basic digitisation process (steps 1 and 2) and the basic movement process (steps 5 and 6), the packing conditions (step 3) and insertion control conditions (step 4) are now discussed with reference to an example implementation using the C and C++ programming languages and operating under the Microsoft™ Windows™ operating system. The implementation used the algorithm as described above but also included features which would allow it to more accurately model the real world packing process. The packing parameters provided can be changed at any time during the simulation.

Referring to FIGS. 12 and 13, the possibility of two different ways of modelling particle insertion into a container 13 are shown. In FIG. 12 particles 14 are added quickly across the width of the container 12 whilst in FIG. 13 the particles 14 are added more slowly from a point source, modelling pouring through a narrow orifice.

The addition of particles along the width of the container is known as a lateral spread insertion technique. In this particular example, up to ten particles are introduced simultaneously from uniformly distributed random positions across the width of the container. If ten particles would be too many to insert simultaneously, the implementation will insert as many as can be comfortably accommodated.

FIGS. 12 and 13 also show two other important features of the implementation. Firstly, upward and downward movements must be carefully balanced to give the desired packing. The desired effect is a diffusive downward particle motion. The diffusive effect helps particles to explore the available space, while the downward effect forces the particles to settle and form a stable packing structure.

The second feature is the use of rotations. As a particle falls it may rotate. In the example implementation random rotations can be allowed or disallowed and this will impact on the packing structure obtained. Any rotations performed are, by default, carried out using the two successive shears technique described above, although any convenient method may be used. Referring again to FIGS. 12 and 13, it can be seen that the packing of FIG. 13 is considerably more dense. This can be attributed to the allowance of rotations, the allowance of rebounding and the slower rate of addition (discussed below).

In many applications a quantitative indication of packing density will be required. The packing density may be represented as a measurement of the number of pixels per unit area. Referring to FIG. 14, the same packing structure as in FIG. 11 is shown and two graphs of packing density have been calculated, one along the width of the packing space and one along its height. It can be seen that the packing density is approximately constant across the width (lower graph) and is also constant along the height before it quickly tails off at the top of the container where no particles have been packed. As a further example, referring again to FIGS. 12 and 13, the packing densities differ considerably because of the variance in the parameters discussed above. The packing density for FIG. 12 is 0.39 compared with 0.6 for FIG. 13.

In the example of FIG. 14 it has been observed that packing density values decrease very quickly at the top of the container. If average packing density is taken across the whole container this will lead to a misleading result Therefore a more meaningful result may be obtained by resampling across only those parts of the structure which have a packing density greater than two-thirds the maximum.

The effect of rebounding is very effectively shown by FIG. 15. Without rebounding no particles would ever be packed into area 15, however rebounding allows this area to be populated by particles.

In any simulation, it is likely that a scaled down model of the system will be used to model the scenario of interest. So, for example in particle packing, the effect of using a smaller container with a smaller number of particles may be used to model a larger real world application. The example implementation provides features to allow this to occur, while preserving the accuracy of the model. This is provided by offering different options for lateral boundary conditions. Referring to FIGS. 16 and 17, both figures comprise a packing structure on the left with a packing density graph on the right. In FIG. 16 the walls of the square section container are modelled as being solid walls through which no particles can pass. It can be seen in FIG. 16 that this results in some gaps in the packing at the boundaries. In contrast, in FIG. 17 the particles are allowed to pass through a wall and are assumed to enter through the other wall at the same time (known as periodical boundary conditions). It can be seen from the packing density graphs that a more dense packing is achieved using periodical boundary conditions at the walls of the container. Thus, bulk properties may be accurately predicted using a small sample by configuring the system to use periodical boundary conditions. Referring to the graphs it can be seen that the packing at the walls is considerably denser in FIG. 17.

Reference is made to FIGS. 18 to 20 by way of summary. All these figures show periodical boundary conditions. FIG. 18 shows the effect of inserting particles slowly (at a rate of one particle every fifty time steps) from a central point source. It can be seen that this leads to a partial order within the resulting packing.

FIG. 19 shows the effect of adding particles across the width of the container more quickly (a rate of one particle every five time steps) than in FIG. 18. This leads to a less ordered structure, with more holes present.

FIG. 20 shows the affect of adding at a slower rate (one particle every fifty timesteps) than that of FIG. 19 across the width of the container. Here the packing is dense, with increased order. The only difference between the conditions under which the packings of FIGS. 19 and 20 were achieved is the speed of addition. It can be seen that this has considerable impact on the packing structure, as it determines how long a particle has to explore the packing before being locked in by new additions. A slow rate means that particles have more time to explore the packing space and hence means that particles are more likely to find a tight fit. A slower rate of addition therefore yields a higher packing density.

Analysing FIGS. 18 to 20 quantitatively, the packing density of FIG. 18 is 0.840, whilst that of FIG. 19 is 0.816 and that of FIG. 20 is 0.882. The implementation therefore allows a user to determine the packing characteristics that will be achieved from giving insertion conditions. The system therefore allows users to optimise their particle packing parameters to achieve the packing density and other characteristics that they desire.

Effects of physical interaction between particles can be modelled to a limited extent by the implementation. By allowing particles to move from side to side, and up and down, both during and after packing size segregation caused by rapid small amplitude vibration can be modelled. The effects caused can be dramatic as can be clearly seen from FIGS. 21 and 22 where like particles have clustered together, yielding a higher packing density. In the modelling of FIG. 21 and 22 rotation of polygonal shapes was allowed.

It will be clear that in addition to the parameters discussed above, the shape and size of the particles packed will have considerable impact upon the packing structure. This is shown in Table 1.

TABLE 1
Packing densities as a function of particle size

| | Particle diameter | | | | | |
|---|---|---|---|---|---|---|
| | 5 | 10 | 15 | 20 | 25 | 30 |
| Resampled | 0.8549 | 0.9282 | 0.8889 | 0.9082 | 0.8775 | 0.850 [symbol] |
| packing | | | | | | |
| density | | | | | | |
| Area | 0.8400 | 0.7600 | 0.7867 | 0.7900 | 0.7824 | 0.762 [symbol] |
| ratio | | | | | | |
| Relative | 6.95 | −3.23 | 0.16 | 0.59 | −0.38 | −2.95 |
| error | | | | | | |
| in area | | | | | | |

Referring to Table 1, it can be seen that there is no direct relationship between particle diameter and packing density achieved. Relative error is considerably greater with large and small particle sizes in comparison with intermediate particle sizes.

Extensive experiments have been carried out to analyse how particle size and shape, in combination with the other factors discussed above influence a packing structure. The results of these experiments for twenty different examples (indexed 1 to 20) are shown in Table 2.

TABLE 2
Typical packing densities of various shapes and compositions

| Index | Shapes | Samples | Dimensions | Rotate | Orientation | Ratio | Density |
|---|---|---|---|---|---|---|---|
| 1 | Equal circles | [symbol] | 32 × 32 | No | — | — | 0.8746 |
| 2 | Equal ellipses | [symbol] | 32 × 20 | No | Parallel to X | — | 0.8753 |
| 3 | Irregular pentagons | [symbol] | 32 × 32 | No | Random | — | 0.7500 |
| 4 | Irregular pentagons | [symbol] | 32 × 32 | Yes | — | — | 0.8078 |
| 5 | Short fibres | [symbol] | 32 × 8 | No | Random | — | 0.6035 |
| 6 | Short fibres | [symbol] | 32 × 8 | Yes | — | — | 0.7363 |
| 7 | Short fibres + circles | [symbol] | 32 × 8, 15 × 15 | No | Random | 1:1 | 0.7017 |
| 8 | Short fibres + circles | [symbol] | 32 × 8, 15 × 15 | Fibres | — | 1:1 | 0.7690 |
| 9 | Short fibres + circles | [symbol] | 32 × 8, 15 × 15 | No | Random | 1:2 | 0.7396 |
| 10 | Short fibres + circles | [symbol] | 32 × 8, 15 × 15 | Fibres | — | 1:2 | 0.7786 |
| 11 | Short fibres + squares | [symbol] | 32 × 8, 15 × 15 | No | Random(fibres) | 1:1 | 0.6984 |
| 12 | Short fibres + squares | [symbol] | 32 × 8, 15 × 15 | Fibres | Parallel to X | 1:1 | 0.7809 |
| 13 | Short fibres + squares | [symbol] | 32 × 8, 15 × 15 | Both | — | 1:1 | 0.7271 |
| 14 | Stage 3 Koch's snowflakes | [symbol] | 30 × 35 | No | — | — | 0.7593 |
| 15 | Stage 3 Koch's snowflakes | [symbol] | 30 × 35 | Yes | — | — | 0.7021 |
| 16 | Dumbbells | [symbol] | 64 × 32 | No | Parallel to X | — | 0.7391 |
| 17 | Dumbbells | [symbol] | 64 × 32 | Yes | — | — | 0.6847 |
| 18 | Knots | [symbol] | 60 × 54 | No | — | — | 0.6015 |
| 19 | Knots | [symbol] | 60 × 54 | No | — | — | |
| 20 | Dumbbells + snowflakes | [symbol] | 16 × 32, 15 × 18 | Both | — | 1:1 | 0.7233 |

All simulations were performed on a 600×400 of grid of cells (pixels) with ten particles being added in every five hundred time steps. Periodic boundary conditions were used and a value of 0.2 was used for rebounding probability. Allowance of rotations is shown in the table. The dimensions quoted in Table 2 are averages of the bounding boxes for the shapes. For multi-component mixtures, the ratios are between particle numbers (that is not volumes, areas, or weights). If rotation is allowed, the initial orientation of the particles no longer matters.

Referring to Table 2, two further points should be noted. First, although rotation usually results in a more compact structure, this is not always the case. If rotation destroys an otherwise ordered structure, the packing may be less compact. For example the packing density in example index 14 is considerably higher than that for index 15 even though rotations have been allowed. This can be attributed to the loss of order caused by rotations. Indices 16 and 17 show similar properties

The second point to note is that in certain cases the resampling procedure (described above) can result in an overestimation of the true packing density. For example, in index 18 of Table 2, typical local density is 0.57, smaller than the resampled mean value of 0.61 reported in Table 2. The overestimation comes from the fact that the density profile, from which the resampling is performed, contains periodical fluctuations, due to the hollow structure of the knots, larger than the range over which the resampled average is taken. Thus only peaks are included by the resampling.

Referring to FIG. 23, the graph is a plot of the resampled packing density as a function of the aspect ratio for two types of ‘fibres’: one with rounded ends and the other flat ends (more like rectangles). The packing conditions for all the simulations were kept the same, that is random orientation for all the fibres, no rotation, periodical boundary conditions in lateral directions, rebounding probability 0.2, rain model and the rate of particle addition ten particles every five hundred time steps. In all the simulations, the length of the fibres was fixed at 30, varying aspect ratios were achieved by varying the thickness of the fibres. The starting point for both types is the same, since for a thickness of 1, it makes no difference whether the ends are round or flat. However, for a thickness of 30, the round-ended fibres become circles, and flat-ended fibres become squares; and their packing densities differ the most—crystalline packing structure for the circles as opposed to the still random packing of squares.

It will also be clear to those skilled in the art that the algorithm could be adapted to function with deformable objects, by the inclusion of further user variable parameters, including for example a deformability factor of each particle type to be modelled. Similarly the method could be adapted to model soft materials such as foodstuffs or biological materials. The effects of melting or sintering as seen in powder metallurgy could also be modelled. It is also feasible to allow particles to grow (e.g. due to precipitation) or dissolve (e.g. due to chemical reaction) whilst being packed, by adding or removing pixels/voxels in a defined manner.

An attempted move to enable overlap detection may comprise translational movement, rotation and, for deformable objects, internal rearrangement of pixels or voxels. Here, ‘internal’ means after the trial move the pixel is still part of the particle. It is not confined to movements by interior pixels. In the example implementation, a translational trial move is always performed in a stepwise manner. If the effect of some real world inter-particle interactions are considered, it is necessary to allow particles to move by more than one grid at a time. Rotation is random in the implementation, but if physical particle interactions are to be considered, the direction and amount of rotation will be determined by physical laws.

There are many potential uses for the application of the invention to particle packing. These include calculation and study of the maximum packing density achievable for predetermined particles in a predetermined container, and the influence of the composition of the mixture on packing density, that is the benefit or detriment of packing particles of different shape together. Additionally, as observed above, the effect of packing methods such as rate and mode may be observed, as may container shape.

The modelling of interparticulate interactions has been briefly discussed above and it will be appreciated that the method could be adapted to model additional forces. It is likely however that this may require floating point calculations as opposed to the all integer approach that is used in the example implementation.

A secondary use for the digitised packing structures which results from this algorithm is the prediction of structure-dependent properties (e.g. thermal or electrical conductivity, gas permeability, mechanical strength, or compaction etc) at a microscopic level based on first principles. Using an iterative finite difference approach the interactions between each pixel and its nearest neighbours (four in two-dimensions) are considered. The neighbours of a pixel are shown in FIG. 24. The regularity of the grid makes inter-cell transfers easy to calculate and over time the transfer of heat between cells may be modelled. Although each cell is considered only in relation to its nearest neighbours the propagation of heat between cells in the context of the whole system can be modelled.

Referring to FIG. 25, here the alphabets of the structure of FIG. 11 are considered to be heat sources and progressively lighter grey colouring indicates increasing temperature. The packing structure is shown as time progresses. (i.e. the lowermost image is the latest). In the uppermost image only the alphabet characters are hot, whilst in the intermediate image this heat has spread considerably through the structure. In the lowermost image it can be seen that heat has travelled still further.

This pixelisation of the packing space therefore provides an efficient and convenient way to calculate and predict heat transfer characteristics of the packed particles.

In the above descriptions, some parts of the invention are described as applied to two-dimensional situations where the container and particles are considered to be made up of pixels. It will be clear to those skilled in the art that an 3-dimenenstional implementation of the algorithm using voxels will be possible as mentioned above. It should also be apparent that the grid need not consist of squares or cubes but could, in two-dimensions, be made up of triangles, hexagons or other shapes instead.

It has been observed that in the implementation described many of the operations take place in a random manner leading to random packing. In some applications this may not be the desired result. It is therefore possible to generate ordered packing structures by, for example, only allowing particles to follow certain ballistic trajectories (which are of course also digitised). In between ordered and random packing, controlled or guided packing can also be realised by, for example, directing particles to fill certain holes, removing particles which are causing deadlocks, or introducing particles in a particular order designed to maximise the packing density. In a three-dimensional implementation, Virtual Reality techniques can be utilised to aid the control process.

Immobilisation of certain particles is not only a measure to achieve controlled packing but also helps to speed up the simulation, especially when applied to large numbers of particles. The simulation can allow particles that have not been successfully moved over the last definable number of time steps to be fixed in place, that is taken out of consideration for subsequent trial moves. Another option allows particles whose index is below a definable value to be fixed. Since particle index corresponds to the order of packing, this option can effectively take a large part of the packing out of the subsequent computation.

Other measures of optimisation of the invention include using binary or bit, instead of integer, representation of the pixels. Use of bit representation immediately gives a saving in computer memory by a factor of 32 (assuming that an integer is represented by 32 bits as is common in the art). Although bit operations may be slower than integer operations, for large scale packing the saving in memory may still outweigh the increase in CPU time. Bit representation may not be suitable if some other information needs to be stored in-situ with the pixel data.

The application of the invention to the study of particle packing offers a number of advantages over the existing means of study discussed early in this document. Some of these are summarised below:

The method of the invention is not limited to mathematically or computationally simple shapes. It can be applied to any digitally stored image. Since the objects reside and move in a grid, collision and overlap detection is now a simple matter of detecting whether two objects occupy the same site(s) at a given time, rather than having to compute and test intersections between objects, which is usually the most expensive part of such particle simulations. For a predetermined resolution, the number of pixels used to represent a shape, hence the computational cost, depends on the area (in two-dimensions) or volume (in three-dimensions) of the shape, and does not necessarily increase with the complexity of the shape. In contrast, a conventional (e.g. polygonal or sphere composite) approach generally uses more elements to represent more complex shapes.

The use of pixels or voxels means that the computations involved are mostly integer operations. For single processor computers, today's PCs (e.g. having a 450 Mhz Intel™ Pentium™ III processors) have a very similar integer performance to the much more expensive Reduced Instruction Set Computer (RISC) workstations. For example integer performance of PCs in industry standard tests is similar to that of high end work stations while the floating point performance of PCs still lags behind RISC workstations considerably.

As with any other algorithm, the digital approach has its own limitations. For example, it may be as memory intensive as some traditional shape representations. Although it is possible to significantly reduce memory requirement, this will be at the cost of speed. For simple shapes such as spheres, the digital algorithm may be no faster than well implemented traditional (ballistic) algorithms. Some techniques, for instance feature reduction (described in J. K. Dickinson and G. K. Knopf: Generating 3D packing arrangements for layered manufacturing, Rensselaer's International Conference on Agile, Intelligent and Computer Integrated Manufacturing, Troy, N.Y., October 1998) used by some conventional approaches to speed up program execution, cannot be used for the digital approach with the same success, because the number of pixels/voxels required depends more on the area/volume than the complexity of a shape. Quantitative prediction of packing characteristics such as packing density is sensitive to the resolution used, and the sensitivity is usually non-linear and shape-dependent.

Despite these limitations, the simplicity, ease of implementation and the speed of the digital algorithm make it an attractive alternative to the traditional packing algorithms when it comes to packing particles of arbitrary shapes.

1. A computer implemented method for simulating interactions between relatively movable objects wherein a space to be modelled is mapped to a grid of cells each of which is a basic spatial element; a first object is mapped to a first set of grid cells representing the shape of the first object and a second object is mapped to a second set of grid cells representing the shape of the second object, movement of at least one of the objects through the modelled space is simulated by mapping the moved object to an updated set of grid cells selected to represent the shape of the moved object after a predetermined stepwise movement of the object, and movements which would result in sets of cells representing different objects including a common cell are precluded.

2. A method according to claim 1, wherein one of the objects represents the sides of a container into which another object is to be packed.

3. A method according to claim 1 or to claim 2, wherein each grid cell is a pixel or a voxel.

4. A method according to any preceding claim, wherein movement in a predetermined direction is allowed only in accordance with a specified probability factor.

5. A method according to any preceding claim, wherein the movement of an object includes rotation.

6. A method according to any preceding claim, wherein a plurality of objects may move simultaneously.

7. A method according to any preceding claim, wherein means are provided to simulate the effects of physical forces between objects.

8. A method according to claim 7, wherein the means provided simulate inter object vibration by allowing objects the freedom to move in a predetermined manner relative to the grid after a collision is detected.

9. A method according to any preceding claim, wherein one object represents a boundary of a container.

10. A method according to any preceding claim, wherein a boundary is defined and a periodical boundary condition or virtual wall boundary condition is applied to any object which overlaps the defined boundary.

11. A method according to any preceding claim, wherein means are provided to simulate the addition of objects to the container at a common point.

12. A method according to any one of claims 1 to 10 wherein a plurality of objects may be added at any time from a plurality of points.

13. A method according to any preceding claim wherein an object colliding with another object or with a boundary deforms in a predetermined way.

14. A method substantially as hereinbefore described with reference to the accompanying drawings.

15. An device for carrying out the method of any preceding claim.

16. A device for carrying out the method substantially as hereinbefore described with reference to the accompanying drawings.
